(19) United States
(12) Patent Application Publication
(10) Pub. No.: US 2022/0012686 A1
(43) Pub. Date: Jan. 13, 2022

(54) Package Delivery Notification and Confirmation System

(71) Applicants: A'kela Kirby, Wilson, NC (US); Nathaniel Howell, Garner, NC (US)

(72) Inventors: A'kela Kirby, Wilson, NC (US); Nathaniel Howell, Garner, NC (US)

(21) Appl. No.: 17/374,717

(22) Filed: Jul. 13, 2021

Related U.S. Application Data
(60) Provisional application No. 63/051,334, filed on Jul. 13, 2020.

(51) Int. Cl. G06Q 10/08; G06K 19/06; G06K 7/14; G06F 16/29

(52) U.S. Cl. CPC G06Q 10/0838; G06K 19/06028; G06Q 10/0833; G06K 7/1413; G06F 16/29; G06K 19/06037; G06K 7/1417; G06Q 10/0832; G06K 7/1447

(57) ABSTRACT

A system and method for providing package delivery notification and confirmation using barcodes corresponding to delivery addresses according to the present invention is disclosed. The system includes a web server with a network connection to one or more remote devices over a network. The network is configured to communicatively interconnect the web server and one or more client devices. The remote device has a memory having instructions of the mobile application, and a processor configured to execute the instructions of the mobile application causing the remote device to obtain delivery information from a package to be delivered, generate a delivery notification message, transmit the delivery notification message to the web server, and receive a server response to the delivery notification message.

### CROSS-REFERENCE TO RELATED APPLICATION

This application claims priority to U.S. Patent Application No. 63/051,334, titled “Package Delivery Notification and Confirmation System,” and filed on Jul. 13, 2020. The entire application is incorporated herein by reference in its entirety.

### TECHNICAL FIELD

This application relates in general to a system and method for providing package delivery services, and more specifically, to a system and method for package delivery notification and confirmation using barcodes corresponding to delivery addresses.

### BACKGROUND

In 2019, the United States Postal Service delivered 6.2 billion packages. Federal Express and United Parcel Service delivered another 11 billion packages. Some industry experts estimate that up to 11% of those packages are misdelivered. That's nearly 2 billion misdelivered packages. Most of these mis-deliveries occur when a driver arrives at an address that doesn't match the address on a package. They either leave the package anyway or return it to the truck for troubleshooting.

Therefore, a need exists for a system and method providing package delivery notification and confirmation using barcodes corresponding to delivery addresses.

### SUMMARY

In accordance with the present invention, the above and other problems are solved by providing a system and method for package delivery notification and confirmation using barcodes corresponding to delivery addresses according to the principles and example embodiments disclosed herein.

In one embodiment, the present invention is a system for providing package delivery notification and confirmation using barcodes corresponding to delivery addresses. The system includes a web server with a network connection to one or more remote devices over a network. The network is configured to communicatively interconnect the web server and one or more client devices. The remote device has a memory having instructions of the mobile application; and a processor configured to execute the instructions of the mobile application causing the remote device to obtain delivery information from a package to be delivered, generate a delivery notification message, transmit the delivery notification message to the web server, and receive server response to the delivery notification message.

In another aspect of the present invention, the remote device obtains delivery information by obtaining delivery location data, obtaining package tracking information, and obtaining GPS location information.

In another aspect of the present invention, the remote device obtains delivery information by obtaining a first image of the package at a delivery location, obtaining a second image of a recipient receiving the package when a recipient receives the package, obtaining an image of the delivery personnel at the delivery location, and obtaining an image of any signature obtained from the recipient receiving the package

In another aspect of the present invention, the delivery location data is obtained from scanning a location barcode at the delivery location containing information describing the location.

In another aspect of the present invention, the location barcode contains an identification ID that identifies the location to data stored within the web server.

In another aspect of the present invention, the location barcode corresponds to a QR code containing delivery information comprising one or more of the following: a name and billing address of the recipient, the delivery address corresponding to the location of the QR code, special delivery instructions that the driver may obtain from the data within the QR code, and GPS location data of the delivery location previously obtained and encoded within the QR code.

In another embodiment, the present invention is a method for providing package delivery notification and confirmation using barcodes corresponding to delivery addresses. The mobile application obtains delivery information from a package to be delivered, generates a delivery notification message, transmits the delivery notification message to the web server, and receives a server response to the delivery notification message.

The foregoing has outlined rather broadly the features and technical advantages of the present invention in order that the detailed description of the invention that follows may be better understood. Additional features and advantages of the invention will be described hereinafter that form the subject of the claims of the invention.

It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only, and is not intended as a definition of the limits of the present invention.

### BRIEF DESCRIPTION OF THE DRAWINGS

Referring now to the drawings in which like reference numbers represent corresponding parts throughout:

FIG. 1 illustrates an example embodiment of a system and method that provides package delivery notification and confirmation using barcodes corresponding to delivery addresses according to the present invention.

FIG. 2 illustrates another example embodiment of a system and method for providing package delivery notification and confirmation using barcodes corresponding to delivery addresses according to the present invention.

FIG. 3 illustrates an example embodiment of a delivery notification message used in a system and method for providing package delivery notification and confirmation using barcodes corresponding to delivery addresses according to the present invention.

FIGS. 4a-b are flowcharts corresponding to a method performed by software components on a web server and in a mobile application for providing package delivery notification and confirmation using barcodes corresponding to delivery addresses according to the present invention.

FIG. 5 illustrates a generalized schematic of a programmable processing system and method utilized as the various computing components described herein used to implement an embodiment of the present invention.

### DETAILED DESCRIPTION

This application relates in general to a system and method for providing package delivery services, and more specifically, to a system and method for package delivery notification and confirmation using barcodes corresponding to delivery addresses according to the present invention.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In describing embodiments of the present invention, the following terminology will be used. The singular forms “a,” “an,” and “the” include plural referents unless the context clearly dictates otherwise. Thus, for example, reference to “a needle” includes reference to one or more of such needles and “etching” includes one or more of such steps. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact, but may be approximated and/or larger or smaller, as desired, reflecting tolerances, conversion factors, rounding off, measurement error and the like, and other factors known to those of skill. Further, unless otherwise stated, the term “about” shall expressly include “exactly

The term “mobile application” refers to an application executing on a mobile device such as a smartphone, tablet, and/or web browser on any computing device.

The terms “customer,” “client,” and “user” refer to an entity, e.g. a human, using the package delivery notification and confirmation system and method including any software or smart device application(s) associated with the invention. The term user herein refers to one or more users.

The term “connection” refers to connecting any component as defined below by any means, including but not limited to, a wired connection(s) using any type of wire or cable for example, including but not limited to, coaxial cable(s), fiberoptic cable(s), and ethernet cable(s) or wireless connection(s) using any type of frequency/frequencies or radio wave(s). Some examples are included below in this application.

The term “invention” or “present invention” refers to the invention being applied for via the patent application with the title Package Delivery Notification and Confirmation System. Invention may be used interchangeably with delivery notification and confirmation.

The terms “communicate” or “communication” refer to any component(s) connecting with any other component(s) in any combination for the purpose of the connected components to communicate and/or transfer data to and from any components and/or control any settings.

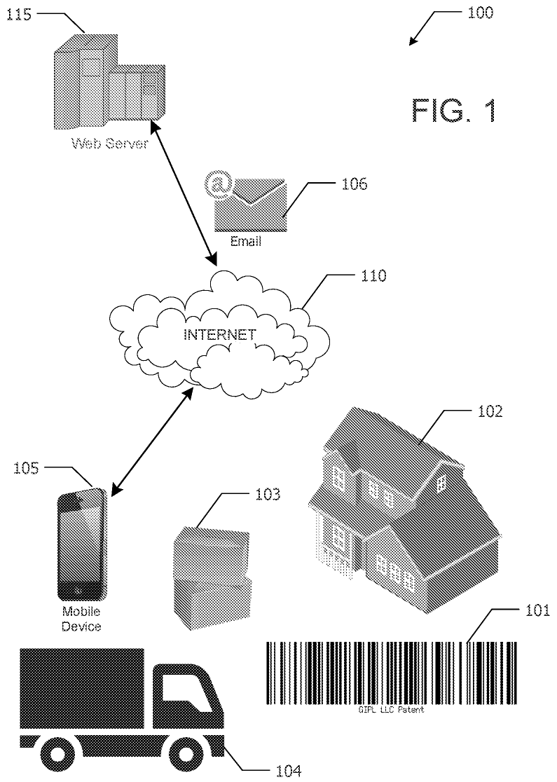

In general, the present disclosure relates to a system and method for providing package delivery confirmation services. To better understand the present invention, FIG. 1 illustrates an example embodiment of a system that provides package delivery notification and confirmation using barcodes corresponding to delivery addresses according to the present invention. The package delivery notification and confirmation system 100 utilizes a web server 115 connected to a mobile application 105 over the Internet 110 to obtain notification of the delivery of a package 103 by a delivery driver 104 that may be confirmed using a recipient barcode 101 displayed at a delivery address. The delivery driver 104 arrives at a delivery address 102 with a package 103 to leave the package 103 for the recipient. The delivery driver 104 locates and scans the recipient location barcode 101 using a mobile application 105 on a smartphone that generates and transmits a delivery notification message 142 to a web server 115.

The recipient location barcode 101 may contain encoded data identifying the recipient and the location where the location barcode is found. The recipient location barcode 101 may be a standard barcode having a unique recipient ID number which corresponds to data maintained by the web server 115. The recipient location barcode 101 also may be a QR code containing additional information encoded directly within the QR code. This additional information may include a name and billing address of the recipient, the delivery address corresponding to the location of the QR code, special delivery instructions that the driver may obtain from the data within the QR code, and any other relevant data useful to aid the delivery of the package. The data obtained from the QR code may be compared to the shipping information associated with the package to verify that the delivery location is correct. The QR code may also provide GPS location data associated with the delivery location that may be compared with a currently obtained GPS location obtained by the mobile application 105 from components of the remote device. If these GPS data locations do not match each other, the driver may infer that the QR code has been moved and may not be valid.

The web server 115 processes the delivery notification message 142 to confirm that the package 103 is being delivered to the correct delivery address 102. The web server 115 may respond to the mobile application 105 with an acknowledgement message indicating that the delivery is at the correct location. The delivery driver 104 may leave the package 103 at the delivery address 102 and move on to the next delivery. When the delivery driver 104 receives an error message instead of the acknowledgement message, the delivery driver 104 may take action to locate the correct address or retain the package 103 to be returned to the delivery driver's 104 dispatch location for additional action.

The web server 115 stores all delivery notification messages 142, acknowledgement messages, and error messages in a data store 125 for later use. The web server 115 also may generate and send one or more delivery notification emails 106 to interested parties to provide notification of a delivery to a verified address. These interested parties may include the recipient, the sender, and any other party identified when the package 103 is processed for shipping.

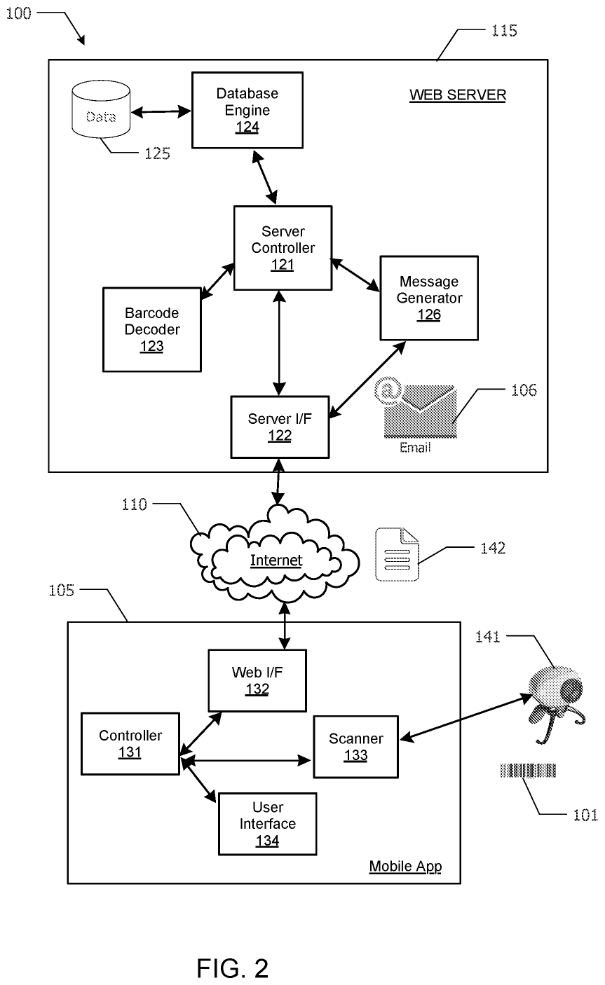

FIG. 2 illustrates another example embodiment of a system and method for providing package delivery notification and confirmation using a recipient barcode 101 corresponding to a delivery address 102 according to the present invention. The mobile application 105 communicates with the web server 115 over the Internet 110 when a delivery driver 104 delivers a package 103 to a delivery address 102. The mobile application 105 comprises a set of processing elements that work together to generate the delivery notification message 142 and to then transmit it to a web server 115. The set of processing elements in the mobile application 105 includes a server controller 121, a server web interface 122, a barcode decoder 123, a database engine 124, and the data store 125.

The server controller 121 receives the delivery notification message 142 via the server web interface 122 when it arrives from the mobile application 105. The server controller 121 parses the delivery notification message 142 into its component data elements and passes the recipient barcode 101 data to the barcode generator 123 for analysis. The server controller 121 also queries the data store 125 via the database engine 124 to obtain data associated with the delivery being made. The server controller 121 will verify a package tracing code 304 received within the delivery notification message 142 with corresponding data received from the data store 125 via the database engine 124. The server controller 121 also verifies the delivery service ID 303 for the package tracing code 304, the barcode address code 305 associated with the package tracing code 304, and the address corresponding to the barcode address code 305 with the GPS data 307 received in the delivery notification message 142. A properly delivered package 103 will have all of these data comparisons match. The server controller 121 then generates the acknowledgement message or an error message based upon the above comparisons. The generated message is sent to a mobile application 105 via the server web interface 122.

The server web interface 122 permits the web server 115 to communicate with the mobile application 105 over the Internet 110. The server web interface 122 performs all of the data formatting, computer-to-computer communications, encryption processing, and all similar operations needed by the web server to communicate with users.

The barcode decoder 123 processes the barcode data received as part of a delivery notification message 142 to obtain the address associated with the recipient barcode 101. This recipient barcode 101 is generated previously by a shipping agent who provides the web server 115 with a delivery address 102 from the recipient when the agent registers with the web server 115. This delivery address 102 should match the address from the package tracking record in the data store 125 as well as the address associated with the GPS data 307 received as part of a delivery notification message 142.

The database engine 124 processes all database operations for the web server 115. These operations include insertion of shipment data, delivery notification messages 142, web server 115 responses into the data store 125, deletion of shipment data, searching and retrieving shipment data from the database 125, and indexing the database 125 to maintain efficient searching when needed.

The data store 125 contains a searchable database of all of the shipping and address data used by the web server 115. All of the data records associated with a shipment are stored in the database as well as all of the delivery addresses 102. Data associated with delivery notification messages 142 and error messages are also added to the database for later use.

The web server 115 also comprises a set of server elements that work together to receive and process the delivery notification messages 142. The set of server elements include a mobile app controller 131, a mobile app web interface 132, a barcode scanner 133, and a mobile app user interface 134 coupled to a barcode scanning device 141.

The mobile app controller 131 interacts and coordinates the processing operations within the mobile application 105. The mobile app controller 131 receives recipient barcode data 101 when the delivery driver 104 initiates a delivery recordation as part of leaving the package 103 at delivery address 102. The mobile app controller 131 generates the delivery notification message 142 and transmits the message to the web server 115. In generating the delivery notification message 142, the mobile app controller 131 obtains current location data for the mobile application 105 from the smartphone that the delivery driver 104 is using to host the mobile application 105. The location data is typically global positioning satellite (GPS) data obtained from circuitry in most smartphones. Location data also may be generated from cell tower triangulation data and Wifi location data used in many processing systems.

The mobile app web interface 132 permits the mobile application 105 to communicate with the web server 115. The mobile app web interface 132 performs all of the data formatting, computer-to-computer communications, encryption processing, and all similar operations needed by the web server to communicate with users.

The barcode scanner 133 is a processing component that obtains recipient barcode 101 data from the barcode scanning device 141 and generates the data to be included within the delivery notification message 142 that is sent to the web server 115. The barcode scanner 133 may receive a barcode image or may receive a digital code generated when the recipient barcode 101 is read. The barcode scanner 133 also may obtain other images for inclusion of data sent to the web server 115. These images may include a current photo of the delivery personnel, an image of any recipient signature received, and one or more photographs showing the location and time of a delivery.

The barcode scanning device 141 corresponds to an electro-optical device that is capable of imaging a recipient barcode 101. The barcode scanning device 141 may generate a barcode image or a digital code generated when the recipient barcode 101 is read. This recipient barcode 101 data are passed to the barcode scanner 133 for further processing.

The mobile app user interface 134 provides input and output processing to provide a delivery driver 104 with messages and data needed to perform the package delivery notification and validation functions. This interface module 134 also accepts commands from the delivery driver 104 to instruct the mobile application 105 to perform these tasks.

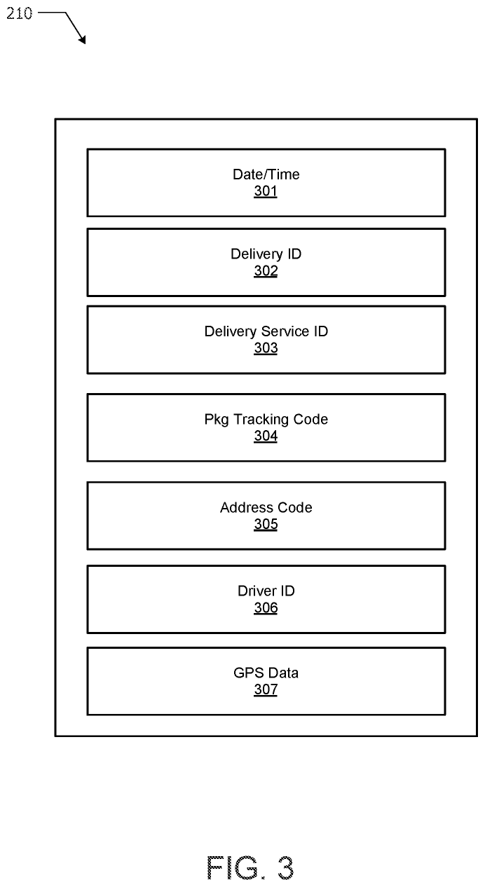

FIG. 3 illustrates an example embodiment of a delivery notification message used in a system and method for providing package delivery notification and confirmation using barcodes corresponding to delivery addresses according to the present invention. The delivery notification message 142 is a formatted data message sent from the mobile application 105 to the web server 115 when a delivery driver 104 attempts to deliver a package 103. The delivery notification message 142 comprises date-time stamp data 301, a delivery ID 302, a delivery service ID 303, a package tracking code 304, a barcode address code 305, a driver ID 306, and a GPS data value 307.

The date-time stamp data 301 corresponds to a data field containing a time stamp corresponding to the date and time when the mobile application 105 is scanning the recipient barcode 101 and generates the delivery notification message 142. The date-time stamp data 301 may be used at a later date when an audit or missing package investigation is performed by the shipper.

The delivery ID 302 corresponds to a unique identifier that is generated for each delivery attempt. The delivery ID 302 is automatically generated by the mobile application 105 to permit the web server 115 and its users to distinguish various delivery events recorded in the data store 125. The delivery ID 302 is used by any acknowledgement message and the error message returned in response to a particular delivery notification message 142.

The delivery service ID 303 corresponds to a unique identifier associated with a shipping company, or a geographic unit of the shipping company that employs the delivery driver 104. The identity of the shipping company or one of its geographically-based units/offices may aid in any audit or missing package investigation performed at a later date.

The package tracking code 304 corresponds to a unique identifier assigned by the shipper when the package 103 is accepted by the shipper for transport and delivery. All packages 103 processed by the package delivery notification and confirmation system 100 will be associated with one, and only one package tracking code 304.

The barcode address code 305 corresponds to the recipient barcode 101 data generated by the barcode scanning device 141 and processed by the barcode scanner 133. The barcode scanning device 141 may generate a barcode image or a digital code when the recipient barcode 101 is read. This recipient barcode 101 data is passed to the barcode scanner 133 for further processing.

The driver ID 306 corresponds to a unique identifier associated with a driver 104. The identity of the delivery driver 104 may aid in any audit or missing package investigation performed at a later date.

The GPS data value 307 corresponds to location data associated with a delivery within the delivery notification message 142. The mobile app controller 131 obtains current location data for the mobile application 105 from the smartphone that the delivery driver 104 is using to host the mobile application 105. The location data is typically GPS data obtained from circuitry in most smartphones. This data is incorporated into the delivery notification message 142 for use by the web server 115.

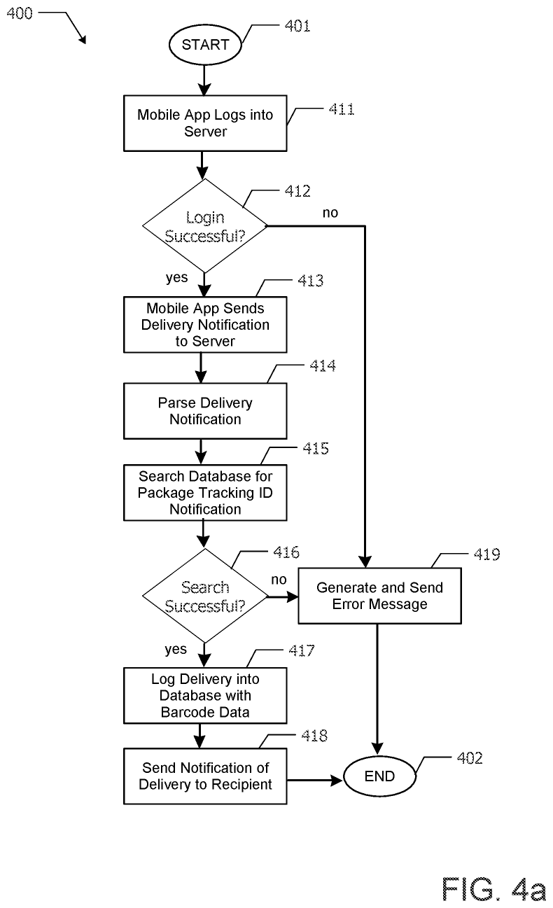

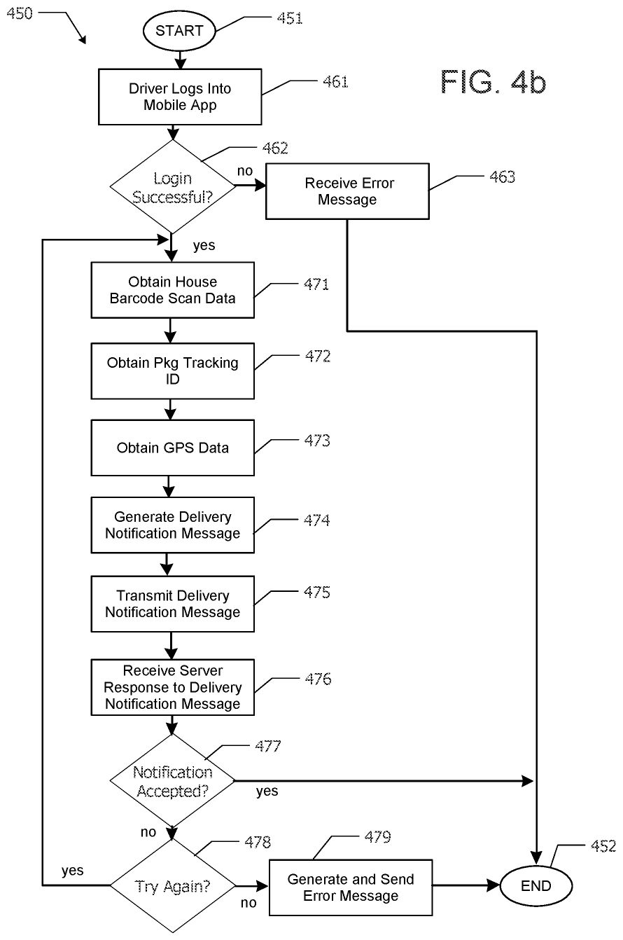

FIGS. 4a-b are flowcharts corresponding to a method performed by software components on a web server and in a mobile application for providing package delivery notification and confirmation using barcodes corresponding to delivery addresses according to the present invention. FIG. 4a shows a sequence of processing operations performed by a web server 115 when a delivery notification message 142 is received from a mobile application 105.

The process begins 401 with a delivery driver 104 logging into the web server 115 in step 411. Step 411 permits the web server 115 to authenticate the mobile application 105 as a valid source of delivery notification messages 142. Test step 412 determines whether or not the log in attempt of the mobile application 105 is successful, and if not, an error message is generated and sent to the mobile application 105 by step 419 and the process ends 402.

When test step 412 determines that the log in attempt of the mobile application 105 is successful, the web server 115 receives a delivery notification message 142 from the mobile application 105 in step 413. Step 414 parses the delivery notification message 142 into its various data fields as defined in FIG. 3. The database engine 124 uses data from the parsed data fields of the delivery notification message 142 to search the database for data associated with a package tracking code 304 in step 415. Step 415 is also responsible for verifying that the package 103 is being delivered to a proper delivery address 102 for the package tracking code 304 and logs all results into the data store 125.

Test step 416 determines whether or not a valid package tracking code 304 was located in the data store 125 and whether the package 103 is being delivered to the proper delivery address 102; if not, an error message is generated and sent to the mobile application 105 by step 419 and the process ends 402. When test step 416 determines the package 103 is being delivered to the proper delivery address 102 associated with the package tracking code 304, the web server 115 logs all results into the data store 125. Step 418 generates and sends notification of a successful package delivery to proper delivery address 102 to all interested parties, including the recipient and the sender. The notification may include information related to the date, time, and location of delivery, the identity of the delivery personnel, identity of individuals receiving the delivery, an image of any recipient signature received, and one or more photographs showing the location and time of a delivery. Once these notifications are transmitted the process ends 402.

FIG. 4b shows a sequence of processing operations performed by a mobile application 105 when a delivery notification message 142 is generated by the mobile application 105 and transmitted to the web server 115. The process begins 451 when a delivery driver 104 logs into the mobile application 105 in step 461. This step permits the mobile application 105 to ensure that the delivery driver 104 is authenticated and authorized to use the mobile application 105. Test step 462 determines whether or not the log in attempt was successful, and if not, the delivery driver 104 receives an error message from the mobile application 105 in step 463 and the process ends 452.

When test step 461 determines that the log in attempt was successful, a recipient barcode 101 is read in step 471 using the barcode scanning device 141. In step 471, the mobile application 105 may also obtain other relevant images. These images may include a current photo of the delivery personnel, an image of any recipient signature received, and one or more photographs showing the location and time of a delivery. The mobile application 105, in step 472, obtains the package tracking code 304 from a barcode located on the package 103. GPS data 307 is obtained from the smartphone by the mobile application 105 in step 473.

Using all of the above data, the mobile application 105 generates a delivery notification message 142 in step 474 and transmits it to the web server 115 in step 475. The mobile application 105 receives a response from the web server 115 in step 476. Test step 477 determines whether or not the web server 115 accepted the delivery notification message 142 as a proper delivery, and if so, the process ends.

When test step 477 determines that the web server 115 did not accept the delivery notification message 142 as a proper delivery, test step 478 determines whether or not the delivery driver 104 wishes to try to verify the delivery address. If the delivery driver 104 wants to try again, the process returns to step 471 to collect all necessary data to generate and submit a delivery notification message 142 for processing. If the driver does not attempt to validate the delivery, step 479 generates and sends an error message and the process ends.

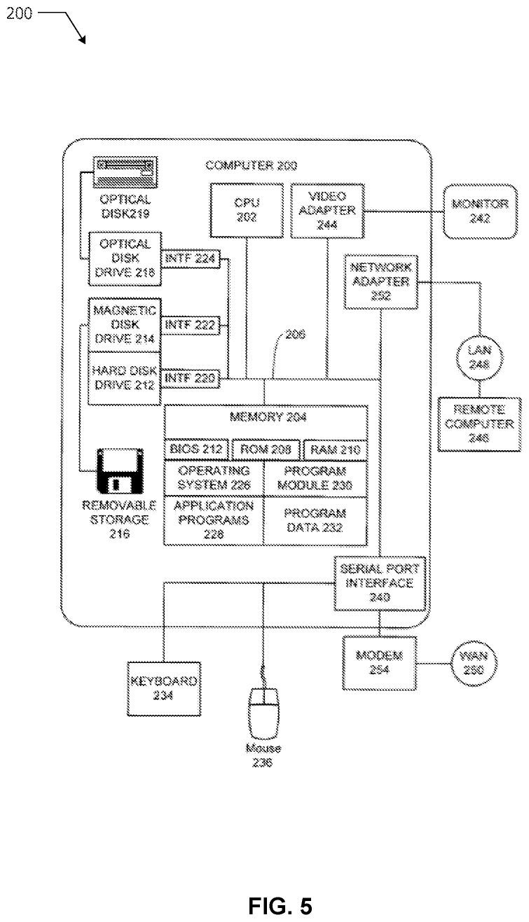

FIG. 5 illustrates a generalized schematic of a programmable processing system and method utilized as the various computing components described herein used to implement an embodiment of the present invention.

The central processing unit (“CPU”) 202 is coupled to the system bus 204. The CPU 202 may be a general-purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 also may include read only memory (ROM) 206 which may be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 also may include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid-state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 also may be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not shown) such as a camera, microphone, video camera, accelerometer, compass, and/or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of a computer system 200. Rather the computer system 200 is provided as an example of one type of computing device that may be adapted to perform the functions of a package delivery confirmation and notification system 100 including the mobile application 105 and web server 115, and servers, personal computers, and mobile devices as shown in FIGS. 1 and 3. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention. This written description provides an illustrative explanation and/or account of the present invention. It may be possible to deliver equivalent benefits using variations of the specific embodiments, without departing from the inventive concept. This description and these drawings, therefore, are to be regarded as illustrative and not restrictive.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

1. A system for package delivery notification and confirmation using barcodes, the system having a web server with a network connection to one or more remote devices over a network, the network configured to communicatively interconnect the web server and one or more client devices, the remote device comprises:
a memory having instructions stored thereon; and
a processor configured to execute the instructions on the memory to cause the remote device to:
obtain delivery information from a package to be delivered;
generate a delivery notification message;
transmit the delivery notification message to the web server; and
receive a server response to the delivery notification message.

2. The system according to claim 1, wherein the remote device obtains delivery information by executing instructions to cause the remote device to:
obtain delivery location data;
obtain package tracking information; and
obtain GPS location information.

3. The system according to claim 2, wherein the remote device obtains delivery information by executing instructions to further cause the remote device to:
obtain a first image of the package at a delivery location;
obtain a second image of a recipient receiving the package when a recipient receives the package;
obtain an image of the delivery personnel at the delivery location; and
obtain an image of any signature obtained from the recipient receiving the package.

4. The system according to claim 2, wherein the delivery location data is obtained from scanning a location barcode at the delivery location containing information describing the location.

5. The system according to claim 4, wherein the location barcode contains an identification ID that identifies the location to data stored within the web server.

6. The system according to claim 4, wherein the location barcode corresponds to a QR code containing delivery information comprising one or more of the following:
a name and billing address of the recipient;
the delivery address corresponding to the location of the QR code;
special delivery instructions that the driver may obtain from the data within the QR code; and
GPS location data of the delivery location previously obtained and encoded within the QR code.

7. A method for package delivery notification and confirmation using barcodes having a web server with a network connection to one or more remote devices over a network, the network configured to communicatively interconnect the web server and one or more client devices, the method comprising:
obtaining delivery information from a package to be delivered;
generating a delivery notification message;
transmitting the delivery notification message to the web server; and
receiving a server response to the delivery notification message.

8. The method according to claim 7, wherein the method further comprises:
obtaining delivery location data;
obtaining package tracking information; and
obtaining GPS location information.

9. The method according to claim 8, wherein the method further comprises:
obtaining a first image of the package at a delivery location;
obtaining a second image of a recipient receiving the package when a recipient receives the package;
obtaining an image of the delivery personnel at the delivery location; and
obtaining an image of any signature obtained from the recipient receiving the package.

10. The method according to claim 8, wherein the delivery location data is obtained from scanning a location barcode at the delivery location containing information describing the location.

11. The method according to claim 10, wherein the location barcode contains an identification ID that identifies the location to data stored within the web server.

12. The method according to claim 10, wherein the location barcode corresponds to a QR code containing delivery information comprising one or more of the following:
a name and billing address of the recipient;
the delivery address corresponding to the location of the QR code;
special delivery instructions that the driver may obtain from the data within the QR code; and
GPS location data of the delivery location previously obtained and encoded within the QR code.
